(19) United States
(12) Patent Application Publication
(10) Pub. No.: US 2014/0040156 A1
(43) Pub. Date: Feb. 6, 2014

(54) Computer System for Financial Aid Packaging for Students

(71) Applicants: Craig V. Carroll, Woollahra (AU); Brandon D. McBride, Arlington, VA (US); John F. Whorley, JR., Indianapolis, IN (US)

(72) Inventors: Craig V. Carroll, Woollahra (AU); Brandon D. McBride, Arlington, VA (US); John F. Whorley, JR., Indianapolis, IN (US)

(73) Assignee: REZOLVE GROUP, INC., Sacramento, CA (US)

(21) Appl. No.: 13/562,631

(22) Filed: Jul. 31, 2012

(51) Int. Cl. G06Q 50/20

(52) U.S. Cl. 705/327

(57) ABSTRACT

A computerized system and method for determining and mitigating risk associated with student lending. The computer system determines a student quality index score, which provides an assessment of how likely the student, such as a student candidate or current student, is to succeed during school and after graduation. Then, based on the student quality index scores of the students, the computer system determines how to structure the financial aid award packages for each individual student to maximize the financial aid provided to the students and enable the academic institutions to be within the mandated lending regulations.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Many students graduating from high school will continue their educational career by attending post secondary institutions. Additionally, it is also common for adults to go back to school later in life to continue (or begin) their education. Generally, these potential students will attend traditional two or four year academic institutions such as colleges or universities or for-profit institutions to obtain technical or vocational training.

While some candidates are able to completely finance their education through personal savings or working while attending school, the vast majority of candidates require reduced tuition rates, student loans, and/or grants to afford the cost of attending most post-secondary institutions. Traditionally, after being admitted to an academic institution, the admitted candidates are required to complete financial aid applications. Then, based on the needs of the students, the academic institution generates a financial aid award package for each candidate.

### SUMMARY OF THE INVENTION

Despite increases in the number of candidates attending post-secondary institutions, access to third-party lending required to finance this education, especially within the for-profit space, is not sufficiently meeting the demand. Approval rates from traditional private lenders remain low due to high default rates in recent years, and for-profit school reputational risk is driving continued scrutiny from industry analysts and investors. Given the market risk of increasing access to for-profit schools and lenders' continued utilization of traditional underwriting scorecards, based primarily on credit bureau data, lenders are unwilling or unable to identify potentially attractive students attending many institutions.

Although for-profit schools are, all else equal, seeking increased access to third-party lending to finance their prospective students, there is an increasing need to identify the ‘right’ students to receive this financing given the latest regulatory changes surrounding student outcomes. In addition to the existing cohort default rate (CDR) requirements (placing a cap on acceptable federal loan default levels), new gainful employment regulations require for-profit academic institutions to show at least a 35% repayment rate, debt-to-income below 12%, and debt-to-disposable income below 30% for students and graduates.

Additionally, failure to meet these mandates can result in the academic institutions losing access to federal student aid programs. Thus, there is a need for lenders and academic institutions to be able to determine and mitigate risk associated with lending to students. The ability to know more, and know it earlier in the student life cycle, will enable schools and lenders to increase access to third-party financing in a responsible and mutually-beneficial manner to all parties involved.

The solution here is to leverage data provided via multiple intake platforms from prospective and current students and score this student data for the likelihood that a student will achieve various forms of academic and financial success. The ability to provide this student assessment is made possible by the creation of predictive models based on historical student performance and outcome data from former students to determine which candidates are likely to succeed during school and/or after graduation.

The present invention is directed to a computer system and method that uses statistical models to analyze application and academic information entered/achieved by candidates/current students and then compare it to historical data collected about former candidates to determine which candidates have the highest likelihood of success. Typically, the statistical models use regression analysis techniques that enable the academic institutions and private lenders to better identify potential risk factors earlier in the application process. The computer system will include student aid estimation technology, calculation engines and decision engines to segment the student population and make various decisions based on the relative likelihood of student success.

Although a more comprehensive and accessible lending solution is, in many cases, the most immediate and relevant utilization of this system and method, the increased level of information gathered from prospective students can enable schools to provide a variety of custom solutions via the segmentation provided by the system and method. In addition to a more scientific financial packaging solution, schools can segment their students based on the need for orientation programs, financial literacy and college readiness education, in-school student services, etc.

In more detail, the computer system determines various lead/student quality index scores, which provide an assessment of how likely the candidate is to succeed during school and after graduation. The ultimate configuration is preferably customized for individual schools, but a preferred embodiment of the method and system allows for Lead Quality Index (LQI) scores to be calculated as prospective students begin the application process, Student Quality Index (SQI) scores based on LQI, FAFSA data, financial literacy and other enrollment-based data, and In-School Student Quality Index (ISQI) scores for continuing students that incorporate the SQI as well as in-school performance data such as GPA, classes taken and hours enrolled. Based on the scores of the candidates, the computer system determines decisions and recommendations related to customized enrollment processes, financial aid award packages, access to third-party financing, in-school student services and collection strategy, all designed to enable the school to manage their operations and revenues on a per-student basis.

In general, according to one aspect, the invention features a computer system for determining financial aid awards of students. The system comprises a user interface that receives personal information of the students, a calculation engine that calculates lead quality index scores for the students based on the personal information of the students and a decision engine that combines the lead quality index scores with additional student information to calculate student quality index scores. The decision engine exports the student quality index scores to lenders and/or academic institutions that provide the financial aid awards to the students based on the student quality index scores.

In embodiments, the personal information includes income, academic performance, and military status of the students, and the additional information is obtained from net price calculation applications, FAFSA, and/or student assessment applications. Preferably, the students are divided into different risk tiers based on the student quality index scores of the students, which tiers segment the students based a level of academic and financial readiness of the students.

The third party lenders and academic institutions usually provide different financial aid awards to the students based on the student quality index scores, in which the financial aid awards include private loans, federal loans, and institutional loans.

Preferably, the system further includes a decision engine that selects which loans to award to the students and possibly a packaging system that combines the selected federal, private, and institutional loans for the students and generates an estimated total award amount.

In general, according to another aspect, the invention features, a computerized method for determining financial aid awards for candidate students and students currently attending an academic institution. The method includes the computer system receiving personal information of the students and then uses this information to calculate a Student Quality Index (SQI) or In-School Student Quality Index (ISQI) score. Again, this calculation engine is developed by creating predictive models that incorporate historical student profiles/performance, leveraging this experience to predict future student outcomes.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram illustrating an overview of the relationship between students, the web server, the computer system, the processing and storage system, data input sources, and data export sources.

FIG. 2 is a hybrid block diagram and flowchart that illustrates the operation of the processing and data storage system of the computer system.

FIG. 3 is a flowchart illustrating the steps performed by the computer system to determine how much financial aid to award the candidates.

FIG. 4 is a hybrid block diagram and flowchart that illustrates the operation of the packaging module.

FIG. 5 is a hybrid block diagram and flowchart that shows how the calculation engine includes current school performance data when calculating student quality index scores of the candidates.

FIG. 6 shows an example of a registration screen that the candidates complete as part of the financial aid application process.

FIG. 7 shows an exemplary academic information screen that requires the potential student to enter information related to academic performance.

FIG. 8 shows an example of a financial information screen that requires the candidate to enter financial information.

FIG. 9 shows an example of a results screen that provides an overview of the next steps in the application process.

### DETAILED DESCRIPTION OF THE PREFERRED EMBODIMENTS

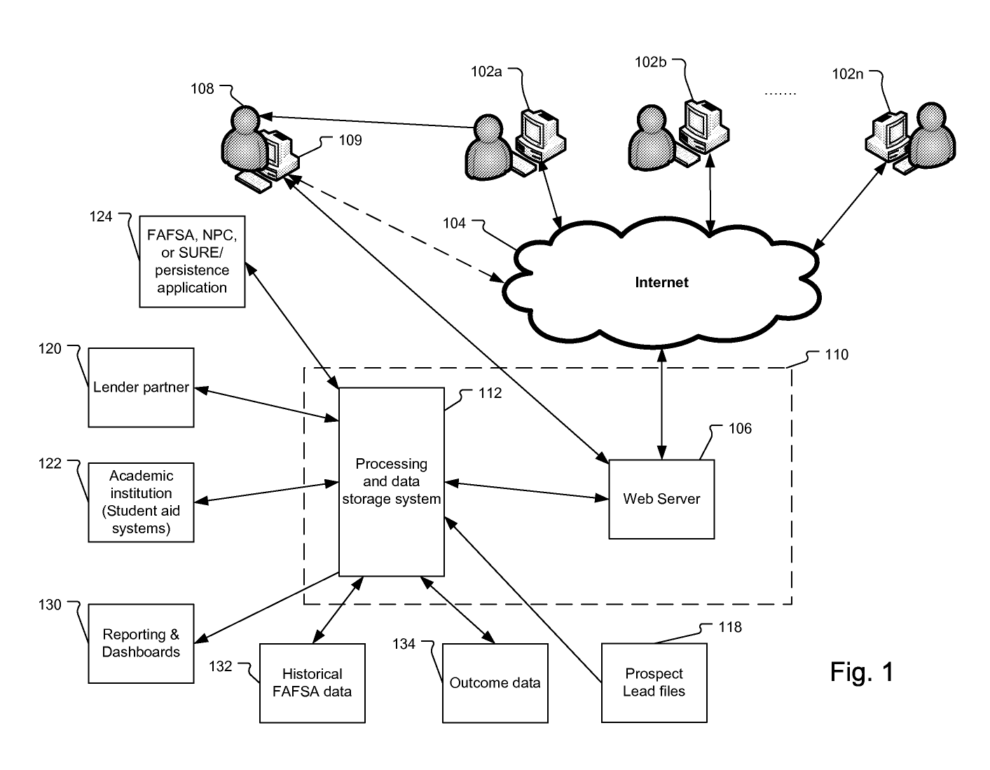

FIG. 1 illustrates an overview of the relationship between candidates 102a to 102n, the Internet or other data network 104, the computer system 110, the academic institutions 122, and lender partners 120.

In a typical implementation, candidates 102a, 102b . . . 102n use personal computers, laptops, tablet devices, or smart phones to access a manage my account (MMA) website hosted by the web server system 106 via a public computer network such as the Internet or other data network 104. The web server system 106 typically includes one or more computers that each include one or more central processing units, data storage mediums such as hard drives, monitors or display devices, and user input devices such keyboards and mice. Additionally, the web server system 106 also includes network connection interfaces to send and receive Internet traffic.

In a preferred embodiment, the candidates 102a-n use Internet browsers to navigate the LQI survey on the school's website, the initial questions ideally positioned as an i-Frame on the front page. The website includes an interface that presents information and questions as part of a survey that the candidates 102a-n must complete. In an alternative embodiment, the candidates 102a-n access the website from a computer terminal or kiosk located on academic institution's campus.

In still another alternative embodiment, the candidates 102a-n contact an advisor 108 that works in, for example, a call center or at the academic institution. The advisor 108 uses an advisor computer 109 that communicates with the web server 106 of the computer system 110. In this scenario, the advisor 108 asks the questions to a candidate 102a and then enters the responses from the candidate 102 into the advisor computer 109 on behalf of the candidate 102a. The advisor computer 109 is typically connected to the computer system web server 106 via a public network such as the Internet 104. Alternatively, the advisor computer 109 could also be directly connected to the web server 106 via local area network connection.

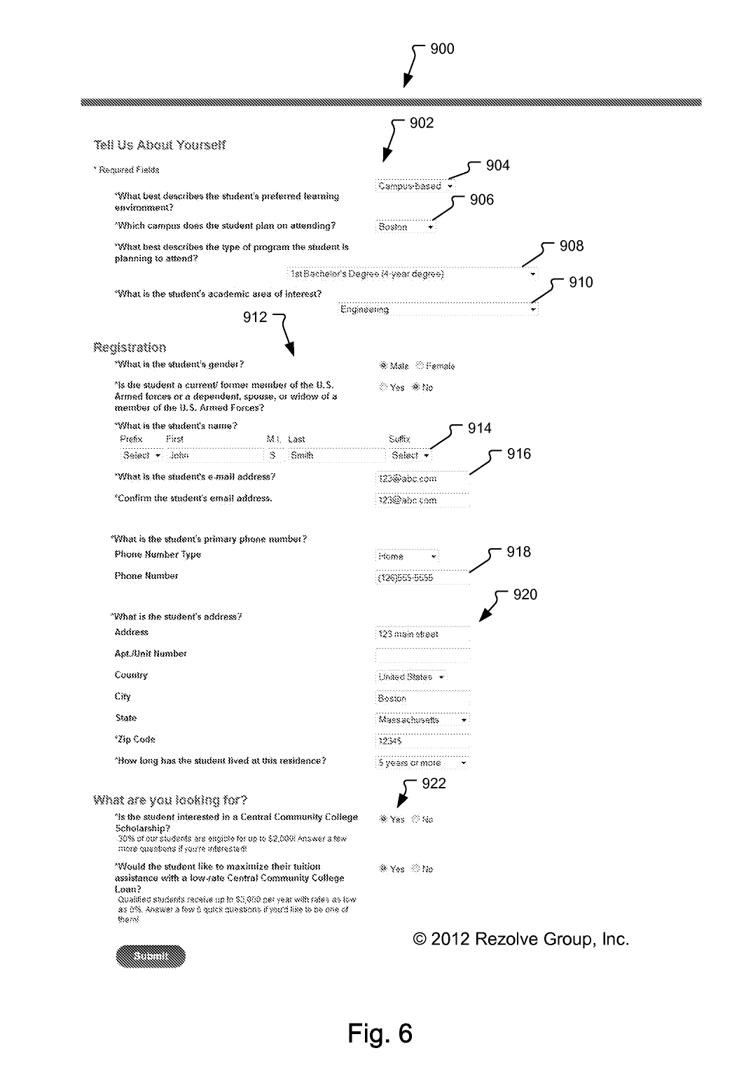

In a preferred embodiment, the interface is presented to the candidates 102a-n by the web server 106 as series of served web pages that guide the candidates 102a-n through a series of interactive screens that display information, directions, and questions that are part of the LQI survey that needs to be completed by the candidates (see FIGS. 6-9). The data from the survey are stored in the processing and data storage system 112 of the computer system 110 and used to calculate a Lead Quality Index (LQI) score, the results of which will drive a decision engine 220 that determines the next step in the customized enrollment process 102a-n.

Often the processing and data storage system 112 is a separate computer system from the web server system 106 that similarly includes one or more computers that each include one or more central processing units, data storage mediums such as hard drives, monitors or display devices, and user input devices such keyboards and mice along with network connection interfaces to be able to send and receive Internet traffic.

In alternative embodiments, information is received by the processing and data storage system 112 from the prospect lead files 118. The lead files are generated, for example, from a separate web property, My Military Aid.com (MMA.com) or from a net price calculator (NPC).

In the case of MMA.com, these lead files provide demographic and financial information input by the candidates/users for the purposes of providing active/veteran military personnel and their families with an estimate of their eligible military assistance available to them for education purposes.

In contrast, NPCs are proscribed by Higher Education Opportunity Act of 2008 (HEOA). Postsecondary institutions participating in Title IV federal student aid programs must post a net price calculator on their websites that uses institutional data to provide estimated net price information to current and prospective students and their families based on a student's individual circumstances. Generally, these NPC's allow students to calculate an estimated net price of attendance based on what similar students paid in a previous year.

After completing the LQI survey, the candidates 102a-n are often required or requested to supply additional information by completing a FAFSA, net price calculation (NPC), or a SURE (Student Understanding and Readiness Evaluation)/persistence (persistence) application. This additional information is stored in a processing and data storage system 112 and later used by the processing and data storage system 112 to supplement the information entered by the candidate when calculating SQI scores. These scores enable strategic segmentation of incoming/existing students for the purposes of providing recommendations for financial aid packaging and increasing access to education financing.

Additionally, the processing and data storage system 112 receives historical FAFSA data 132 and outcome data 134. The historical FAFSA data 132 include FAFSA records with over 130 data points such as earned income, expected financial contribution, assets, and grade point average, to list a few examples. The outcome data 134 include student outcomes with over 250 recorded data points such as enrollment status/history, loan repayment status (e.g., default, complete, ongoing), and loan delinquency history, to list a few examples.

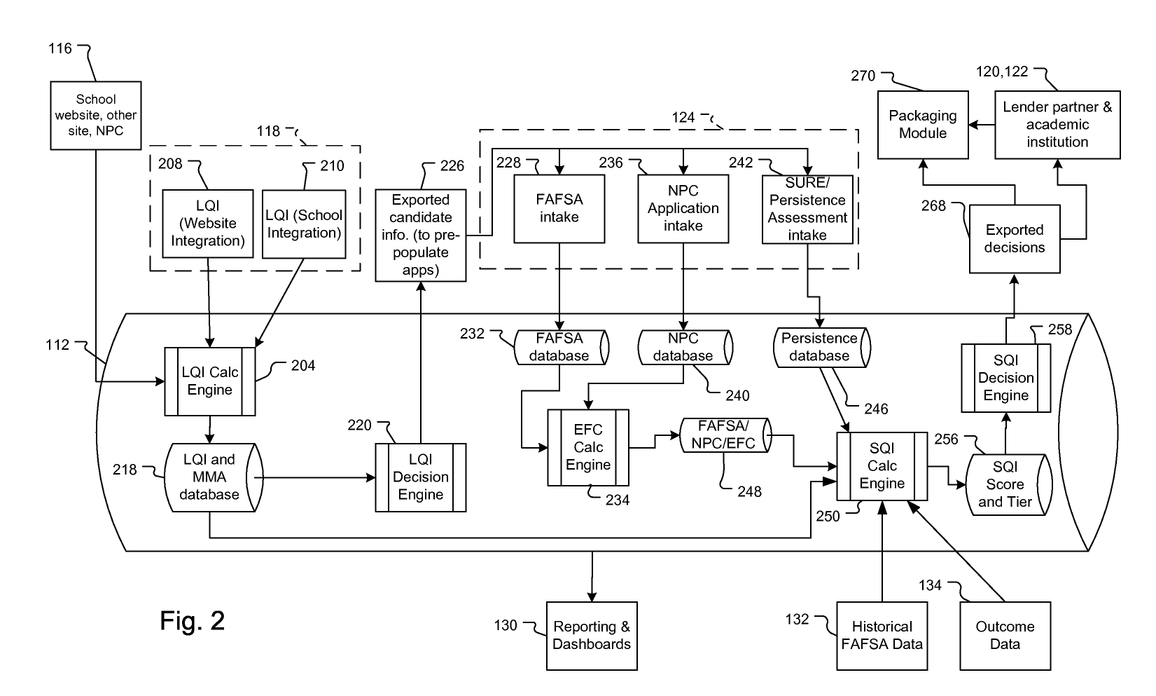

FIG. 2 is a hybrid block diagram and flowchart illustrating the operation of the processing and data storage system 112 of the computer system 110.

In a typical implementation, candidates navigate to the school's website 116 hosted by the web server 106. The web server 106 then presents a survey to the candidates that collects general personal, academic, and financial information (see FIGS. 6-9). In an alternative embodiment, the candidate information is obtained from prospect lead files 118. The lead files could be from a third party source 208 or from an internal source 210. In an alternative embodiment, the candidate information is obtained from a separate web property or the school's Net Price Calculator.

The information of the students is then transferred to the lead quality index (or LQI) calculation engine 204 of the processing and data storage system 112 to generate a lead quality index score for each student. The lead quality index scores are a preliminary assessment of the academic and financial readiness of the candidates to attend academic institutions. The candidate information and lead quality index scores are then saved in a LQI database 218 maintained by the processing and data storage system 112.

Next, the lead quality index scores are transferred from the LQI database 218 to the lead quality index decision engine 220 of the processing and data storage system 112. The lead quality index decision engine 220 uses the lead quality index scores to determine which intake process 228, 236, 242 the candidates should complete. Rather than a “one size fits all” approach and having all the candidates 102a-n complete the same intake process, the present system enables the processing and data storage system 112 to gather specific information about the candidates to better understand the different levels of personal, academic, and financial readiness of the candidates.

In a typical implementation, the candidates 102a-n with highest lead quality index scores are directed to the FAFSA intake process 228. The candidates with the highest scores are the most academically and financially prepared.

The process of filing a FAFSA is required to receive federal aid and is a necessary prerequisite for packaging. Historically, prospective students were simply sent a communication, such as email, by the school with a link to the Department of Education website to complete this process. This process of sending students to an outside source for FAFSA preparation typically results in a large enrollment fallout, and is thus not preferable for the future.

In the present system, the processing and data storage system 112 notifies personnel at a FAFSA filing service to contact the candidate. These filing services are concierge-type offerings that improve the likelihood that attractive students will not be lost in the process, avoiding the fallout. A school typically only provides this service for the most attractive prospects.

In another embodiment, the student completes the FAFSA application online with call-center help, if necessary.

If the school elects to only send the students with the highest scores through the FAFSA process, then an alternate path is provided to candidates with average lead quality index scores. They are sent a communication, such as email, by the processing and data storage system 112 with a link to a net price calculation (NPC) application intake website 236. The net price calculation intake website 236 presents cost information of post-secondary institutions with additional survey questions about the academic and financial performance of the candidates 102a-n to acquire more candidate information and generate a comprehensive analysis of each student's eligibility for student aid programs, the total cost of attending the institution, likely post-graduation debt burden, and monthly loan repayment estimates. A system for computerized net price calculation with total cost and affordability calculation was described in U.S. Pat. Application, “Computerized Net Price Calculation Method and System with Total Cost and Affordability Calculation”, Ser. No. 13/184,067, filed on Jul. 15, 2011 by Carroll et al. now U.S. Pat. No. ______, for example, which application is incorporated herein by this reference in its entirety.

Additionally, the candidates with the lowest lead quality index scores are directed to the persistence application intake process 242. The persistence assessment module, named Student Understanding and Readiness Evaluation (S.U.R.E.) 242, enables the academic institution to gather specific information and provide financial literacy and college preparation courses to the candidates. The module also provides the candidates with information on the net price (via NPC) to attend the academic institution based on the candidates specific financial circumstances. In a preferred embodiment, completion of the financial literacy and college preparation courses will result in an adjustment to the student quality index scores of the candidates.

In a typical implementation, the candidate data from the LQI database 218 are exported to whichever intake process the candidates are directed. This pre-population of candidate information further expedites the intake, reduces errors, and prevents candidate from having to re-enter the same information repeatedly when completing the intake process. The candidate information gathered during the different intake processes 228, 236, 242 are then stored in the FAFSA database 232, NPC database 240, and persistence database 246 respectively, which are maintained by the processing and data storage system 112, in one example.

The candidate data from the FAFSA database 232 and NPC database 240 are then transferred to the expected financial contribution calculation engine 234 of the processing and data storage system 112 to determine an expected family contribution of the candidate. The expected family contribution is how much money a student's family is expected to contribute to the student education. Some factors for determining the family's financial strength include net assets, liabilities, earned income, numbers of members of a household, and other family members currently attending college, to list a few examples. The calculated expected financial contributions for the candidates are stored in the FAFSA/NPC/EFC database 248 maintained by the processing and data storage system 112.

Next, the student quality index calculation engine 250 of the processing and data storage system 112 determines student quality index scores for the candidates. The student quality index scores are calculated by combining the candidate data stored in the LQI database 218, individual FAFSA survey data points, the expected financial contribution from the FAFSA/NPC/EFC database 248, and the persistence database 246 (if the candidate completed that intake process). Student Quality Index scores are calculated by running this data through the calculation engine 250 that is driven by the predictive model created from the analysis of historical student performance. The model, in a current implementation, is built on matching historical student records such as historical FAFSA data 132, with corresponding outcomes and the student records 134 to predict outcomes.

The possible risk tiers are further shown in Table I below. In current implementation, the student quality index scores of the candidates range from 0-60 and there are 7 different risk tiers. Associated with each of the different risk tiers are financial and academic success rates that are derived from the historical FAFSA data 132 and outcome data 134 based on the model created by the processing and data storage system 112. By way of example, a student in “Risk Tier 0” will have a very high probability of persisting (staying enrolled in school), a high probability or successful repayment of student loans, and currently has “excellent” financial and academic readiness. Conversely, a student in “Risk Tier 6” has a very low probability of persisting, a low probability of being able to repay loans, and “very poor” financial and academic readiness.

TABLE I

| SURE Score | | | | | | | |
|---|---|---|---|---|---|---|---|
| (After One Year) | | | | | | | |
| Output: Ability to Pay | | | | | | | |
| score/Persistence score/ | | | | | | | |
| Readiness score | RISK TIERS | | | | | | |
| Score Range: 0-60 | Tier 0 | Tier 1 | Tier 2 | Tier 3 | Tier 4 | Tier 5 | Tier 6 |
| Score Range | >55 | 42-54 | 35-41 | 23-34 | 12-23 | 5-12 | <5 |
| Probability of | >90% | >80% | 61-80% | 41-60% | 21-40% | <21% | <10% |
| Persisting | | | | | | | |
| Probability of | >90% | >80% | 61-80% | 41-60% | 21-40% | <21% | <10% |
| Repayment | | | | | | | |

| | | | | | | |
|---|---|---|---|---|---|---|
| Financial & | Excellent | Very Good | Good | Avg. | Poor | Very |
| Academic | | | | | | Poor |
| Readiness | | | | | | |

While an exemplary table has been illustrated, the number of risk tiers, the probabilities of repayment and/or persistence, and the model used to calculate the student quality index scores are adaptable and modifiable as needed by the academic institutions and lender partners.

The scores and risk tier information of the candidates are saved in the SQI score and tier database 256 maintained by the data processing and storage system 112. Based on the student quality index scores and their associated risk tier, the student quality index decision engine 258 of the data processing and storage system 112 determines recommendations for financial aid packaging decisions, including the optimal mix of federal vs. private lending and which students are potentially eligible for private loans.

Next, exported decisions 268 from the student quality index decision engine 258 are transferred to the underwriting engine of the lender partner 120 and financial aid management systems at academic institutions 122. Ultimately, all data, scores, recommendations, and lending decisions are fed into a school's packaging module 270. The packaging module generates reports, which are sent to candidates, such as printed or email reports. Each of the reports specifies the costs of education at the academic institution for each of the candidates for the upcoming year, federal aid that is available, private loans that are being offered by the lender partner, along with other forms of financial aid that are available to each of the candidates.

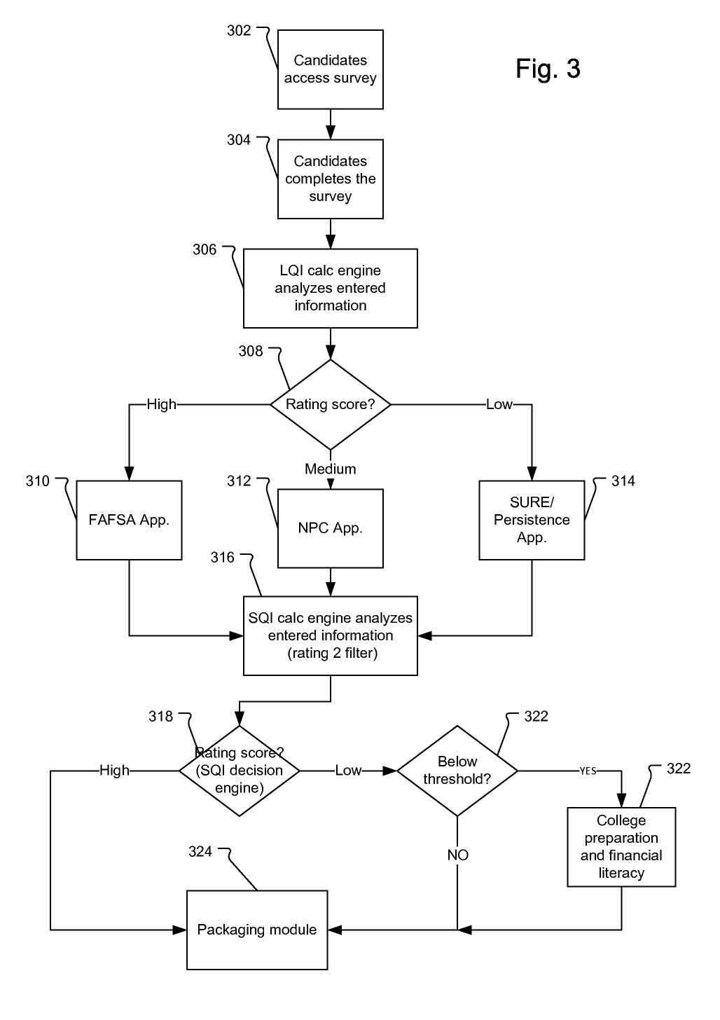

FIG. 3 is a flowchart illustrating an example of the steps performed by the data processing and storage system 116 to determine recommendations for financial aid packaging decisions in a typical implementation.

In the first step 302, the candidates 102 navigate to a website served by the web server 106 typically using personal computing devices such as portable, desktop, or mobile computers. In the next step 304, the candidates complete the survey (see FIGS. 6-9) that is displayed on their computing devices. The information that they enter is transmitted to the web server 106. Generally, candidates complete the survey by entering information into fields in the user interface. In an alternative embodiment, the candidates call an advisor 108 or representative in a call center. In this scenario, the advisor 108 reads the question to the candidates and enters the responses from the candidates into the advisor computer 109.

In the next step 306, the lead quality index calculation engine 214 analyzes the entered information and determines a lead quality index score and rating in step 308. The lead quality index score is a measurement used by the academic institutions to identify risks associated with the candidates and to determine which intake process the candidates need to complete.

If the candidates have high lead quality index scores, then a lead quality index decision engine 220 transfers the candidates to the FAFSA intake process 228. Here, the candidates complete the FAFSA to determine their eligibility for student financial aid such as Pell grants, Federal loans, and/or work study in step 310.

If the candidates have medium lead quality index scores then the candidates are directed to the net price calculation 236 intake processes in step 312. If the candidates have low LQI scores, then the candidates are directed to the SURE/persistence application evaluation intake process 242 in step 314. The SURE app/module is the persistence assessment, and the output can ultimately impact the SQI decisioning.

Generally, the “high”, “medium”, and “low” ranges for the scores are modifiable ranges determined by, for example, a system administrator or department head in charge of managing the decision engine development/administration in consultation with the school because thresholds for the “high”, “medium”, and “low” ranges could vary from year to year (or even semester to semester).

In the next step 316, the student quality index calculation engine 250 analyzes all of the collected information and determines a student quality index score for each candidate in step 318. If the candidates 102 have an SQI score that exceeds the minimum threshold for private lending eligibility, the score and student data are exported to a private lending partner to determine approval. After this decision is made, all information is then exported to the school. If the SQI score is below the eligibility threshold for private loans, the student data are sent directly to the school as the lending step in the process is unnecessary.

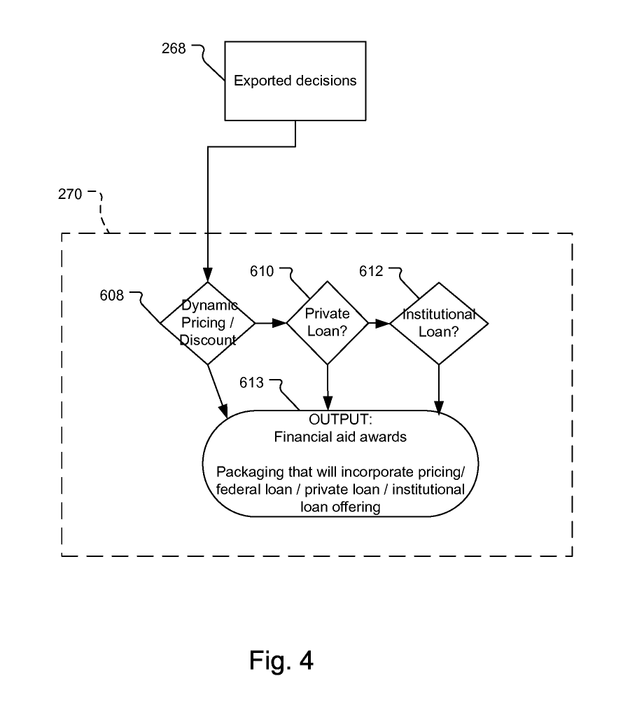

FIG. 4 is a hybrid block diagram and flow chart that illustrates the operation of the packaging module 270 of the processing and data storage system 116. In one implementation, an advantage of the disclosed system is an increased access to third-party lending. The academic institution then receives communications and eligibility and decisions by the lender. The system can also provide packaging recommendations for all financing options (federal, private, institutional aid, etc). Thus, in one example, the packaging module 270 functions as a decision engine within the overall system that is exporting information to a packaging engine of the academic institution, which is actually responsible for generating communications to candidates.

Based on the exported decisions and recommendations 268 from the student quality index decision engine 258, the school's financial aid office would package a student in a way that is optimal for all parties. The packaging module 270 recommends the optimal packaging solution for a student, but the school's packaging engine will ultimately decide how a student is packaged based on, among other things, the generated SQI and the potential eligibility each student has for third-party financing. The recommendation from the packaging module 270, driven by the SQI score, is based on each school's regulatory targets, private loan eligibility, a school's desire to make institutional loans, and each individual student's relative attractiveness and financial need.

This information is then presented to the candidates as an award package. The award package includes information about the cost of the academic institution, estimated student aid awards, a net cost, and additional loans and grants the student qualifies for, and the estimated dollar amount the student will likely receive in private and/or institutional loan. A system for generating individualized award packets is shown in U.S. Pat. Application, “Method and System for Document Generation from Projected Financial Aid Award”, Ser. No. 13/193,040, filed on Jul. 28, 2011 by Carroll et al., which application is incorporated herein by this reference in its entirety.

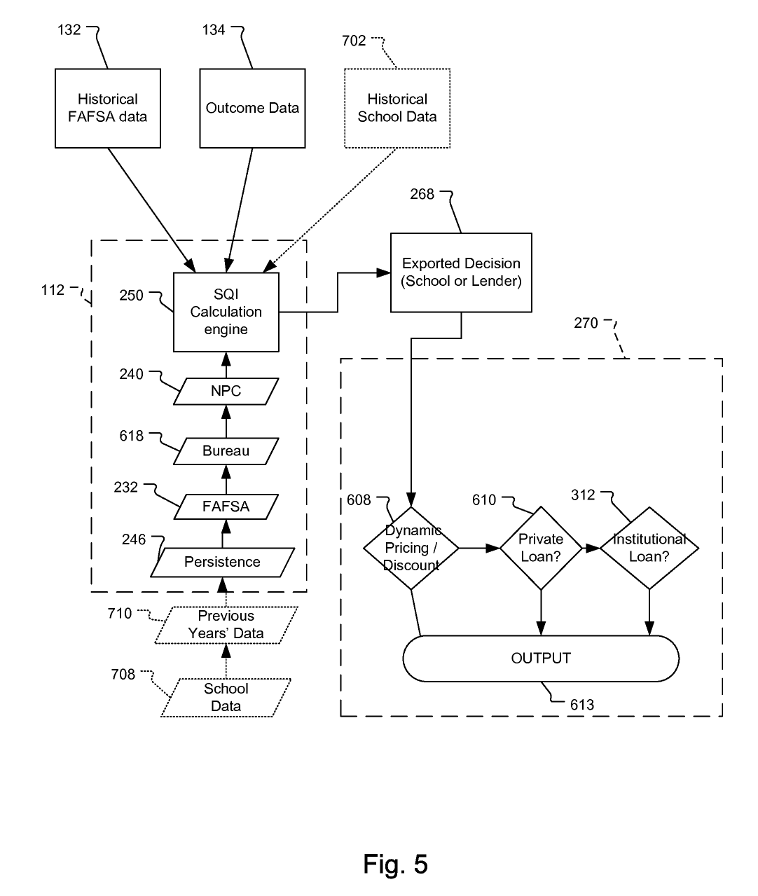

FIG. 5 is a hybrid block diagram and flowchart that shows how the academic institutions and lender partners include school performance data when calculating student quality index scores of the candidates.

As previously described, the student quality index calculation engine 250 incorporates LQI survey data 208, 210, NPC data 240, FAFSA data 232, EFC calculation 234, and persistence data 246. Also as previously described, the calculation engine 250 uses the results of predictive analytics, specifically regression equations output from predictive models, driven by historical FAFSA data 132 and student outcome data 134. Additionally, if applicable, many academic institutions and lender partners also include a credit check from at least one credit bureau 618 prior to lending money to the candidates if a student is potentially eligible and in need of additional funding. This information is then exported to the packaging module 270 and an individualized award package is generated for each candidate.

The analysis of financial and academic performance does not end after the candidates are enrolled. The computer system 110 continues to monitor the performance of the enrolled students throughout their academic careers. Therefore, additional data such as historical school data 702, the current school data 708, and previous years' school data 710 are also incorporated in the analysis while the students are enrolled.

The additional school data typically include enrollment status (part-time/full-time), current grade point average, major, enrolled courses, and/or electives of the candidates, to list a few examples.

FIG. 6 shows an example of a registration screen 900 that the candidates 208 or school advisors 210 complete as part of the Lead Quality Index survey.

In a typical implementation, the candidates 102a-n enter personal information into the computer system 110 via the graphical user interface. The first section is the “Tell Us About Yourself” section 902. In this section, the candidates provide general information such as whether they prefer campus-based or online-based learning 904, which campus they are interested in attending 906, the type of program they are planning to study 908, and which areas of study they prefer 908, to list a few examples.

The next section is the “Registration” section 912 that requires the candidates to enter personal information such as name 914, address 920, email address 916, and phone number 918, and military status, to list a few examples.

Additionally, the registration page 900 also requires the candidates to answer some preliminary questions 922 about whether they will need financial aid from the academic institution.

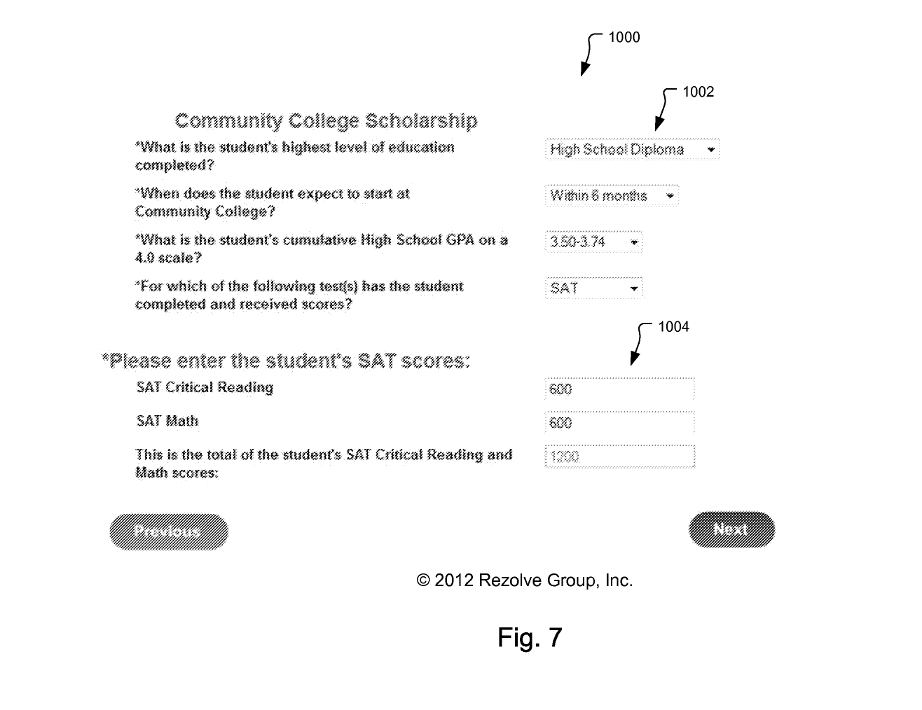

FIG. 7 shows an exemplary academic information screen 1000 that requires the potential student to enter information related to academic performance.

In the illustrated example candidates provide academic performance information 1002 such as academic completion status, grade point average, and which aptitude exams (e.g. SAT, ACT, SAT II) the candidates have taken along with their scores.

If there are additional merit requirements necessary to receive institution specific aid, the academic institution is able to customize their question sets and add more questions to this page or any page within the survey.

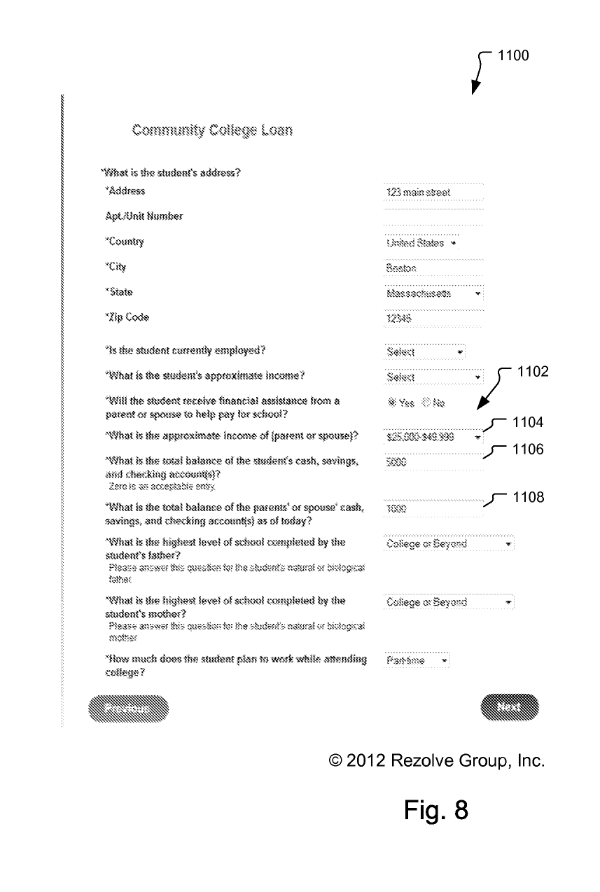

FIG. 8 shows an example of a financial information screen 1100 that requires the candidate to enter financial information 1102.

For example, the candidate is required to enter how much money they made in income 1104, how much they have in savings 1106, and any income and savings of spouses 1108, to list a few examples.

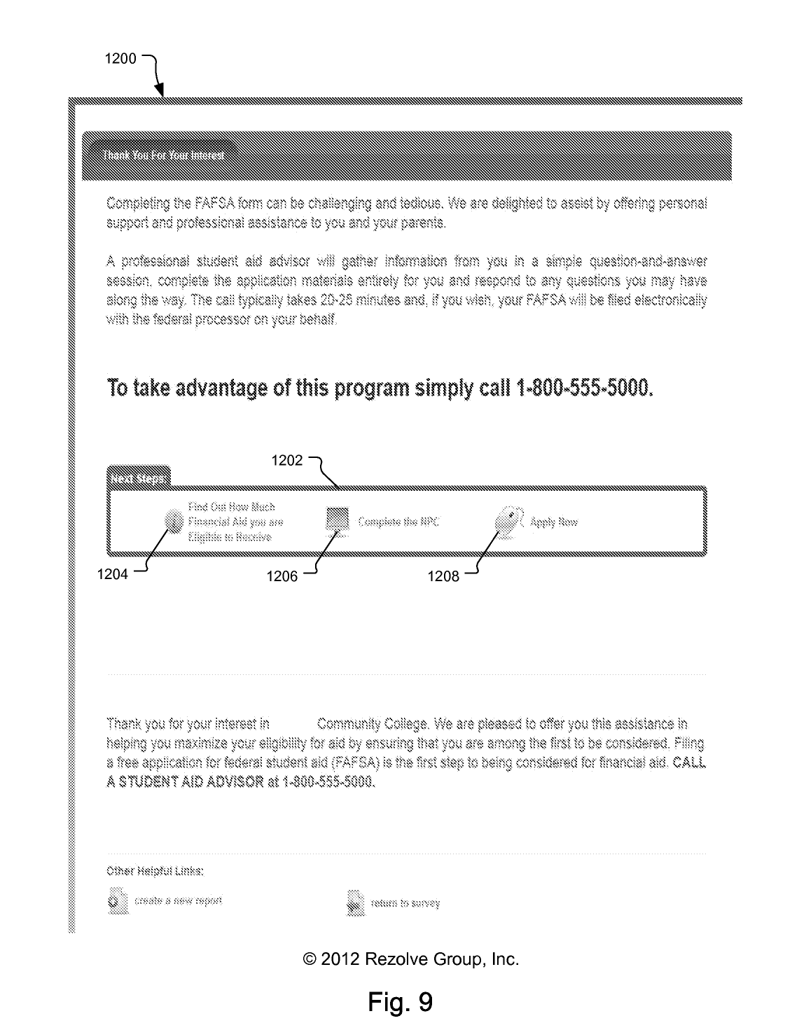

FIG. 9 shows an example of a results screen 1200 that provides an overview of the next steps in the intake process.

The results page 1200 is fully customizable and built in a modular fashion that allows the academic institution to control the content, design, and display of student aid eligibility and net price.

In the illustrated example, the computer system 110 displays different possible intake processes 1202 that the candidate could to complete. The first possible intake process is to find out how much financial aid they are eligible to receive 1204 by completing a FAFSA. The second intake process 1206 is the net price calculator 1206. Lastly, the third intake process 1208 directs the candidates to the persistence application intake process. In operation, however, the candidates would generally only be able to view and continue to the intake process determined by the lead quality index decision engine 250.

While this invention has been particularly shown and described with references to preferred embodiments thereof, it will be understood by those skilled in the art that various changes in form and details may be made therein without departing from the scope of the invention encompassed by the appended claims.

1. A computer system for determining financial aid awards of students, the system comprising:
a user interface that receives personal information of the students;
a calculation engine that calculates lead quality index scores for the students based on the personal information of the students; and
a decision engine that combines the lead quality index scores with additional student information to calculate student quality index scores, the decision engine exporting the student quality index scores to lenders and/or academic institutions that provide the financial aid awards to the students based on the student quality index scores.

2. The system according of claim 1, wherein the personal information includes income, academic performance, and military status of the students.

3. The system according of claim 1, wherein the additional information is obtained from net price calculation applications, FAFSA, and/or student assessment applications.

4. The system according of claim 1, wherein the students are divided into different risk tiers based on the student quality index scores of the students.

5. The system according of claim 4, wherein the different risk tiers segment the students based a level of academic and financial readiness of the students.

6. The system according of claim 1, wherein the third party lenders and academic institutions provide different financial aid awards to the students based on the student quality index scores.

7. The system according of claim 1, wherein the financial aid awards include private loans, federal loans, and institutional loans.

8. The system according of claim 7, further comprising a decision engine that selects which loans to award to the students.

9. The system according of claim 8, further comprising a packaging system that combines the selected federal, private, and institutional loans for the students and generates an estimated total award amount.

10. A computerized method for determining financial aid awards for students attending an academic institution, the method comprising:
a computer system receiving personal information of the students;
the computer system comparing the received personal information of the students to information of former students to calculate student quality index scores for the students; and
the computer system providing financial aid awards recommendations for the students based on the student quality index scores of the students.

11. The method according to claim 10, wherein the information of former students includes academic performance, graduation rates, and repayment history of the former students.

12. The method according of claim 10, wherein the personal information includes income, academic performance, and military status of the students.

13. The method according of claim 10, further comprising obtaining additional candidate information from net price calculation applications, FAFSAs, and student assessment applications.

14. The method according of claim 10, further comprising dividing the students into different risk tiers based on the student quality index scores of the candidates.

15. The method according of claim 14, wherein the different risk tiers segment the students based a level of academic and financial readiness of the candidates.

16. The method according of claim 10, further comprising providing different financial aid awards to the students based on the student quality index scores.

17. The method according of claim 10, wherein the financial aid awards include private loans, federal loans, and institutional loans.

18. A computer system for determining financial aid awards of students, the system comprising:
a calculation engine that calculates quality index scores for the students based on personal information of students and additional student outcome data including loan repayment status and loan delinquency history for other students; and
a decision engine that uses the quality index scores to assess loan repayment probability, the decision engine exporting student information to a lender based on the assessment.

19. The system according of claim 18, wherein the students are divided into different risk tiers based on the scores of the students.

20. The system according of claim 18, wherein the lender is a private lender.
